(19) United States
(12) Patent Application Publication
(10) Pub. No.: US 2008/0174141 A1
(43) Pub. Date: Jul. 24, 2008

(54) Sunshade assembly

(76) Inventor: Chien-Shih Wu, Chiayi Hsien (TW)

Correspondence Address: MCCRACKEN & FRANK LLP, 311 S. WACKER DRIVE, SUITE 2500, CHICAGO, IL, 60606, US

(21) Appl. No.: 11/656,604

(22) Filed: Jan. 22, 2007

(51) Int. Cl. B60J 3/02

(52) U.S. Cl. 296/97.4

(57) ABSTRACT

A sunshade assembly includes a flexible screen body, and a self-coiling spring strip unit that is secured to the flexible screen body and that provides a coiling force for biasing the flexible screen body to roll-up. The self-coiling spring strip unit deforms in a first state, where a cross-section thereof is concave, when straightened, and a second state, where the cross-section thereof is flat, when coiled.

### BACKGROUND OF THE INVENTION

1. Field of the Invention

The invention relates to a sunshade assembly, more particularly to a sunshade assembly that has a relatively simple structure.

2. Description of the Related Art

FIG. 1 illustrates a conventional sunshade assembly that includes a shaft unit 111, a flexible screen body 112, a securing unit 113, and a retaining unit 114. The shaft unit 111 includes a casing 1111, a shaft (not shown) that is disposed rotatably in the casing 1111, and a torsion spring (not shown) that is disposed in the casing 1111 and that biases rotation of the shaft in a first direction. The flexible screen body 112 is wound on the shaft. The securing unit 113 includes a pair of suction cups, each of which is provided on the casing 1111 and is attached removably to a windowpane 10.

In operation, when it is desired to cover the windowpane 10, as best shown in FIG. 2, a free end of the flexible screen body 112 is first pulled. This in turn causes rotation of the shaft in a second direction opposite to the first direction against biasing action of the torsion spring, thereby unwinding the flexible screen body 112 from the shaft. Then, each of the suction cups of the retaining unit 114 is attached to the windowpane 10. Thereafter, when it is desired to uncover the windowpane 10, as best shown in FIG. 1, each of the suction cups of the retaining unit 114 is simply detached from the windowpane 10 to thereby permit rotation of the shaft in the first direction due to the biasing action of the torsion spring, thereby winding the flexible screen body 112 on the shaft.

The aforementioned conventional sunshade assembly is disadvantageous in that it includes the shaft unit 111, which makes the structure thereof relatively complex.

### SUMMARY OF THE INVENTION

Therefore, the object of the present invention is to provide a sunshade assembly that has a relatively simple structure.

According to the present invention, a sunshade assembly comprises a flexible screen body, and a self-coiling spring strip unit secured to the flexible screen body.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional sunshade assembly;

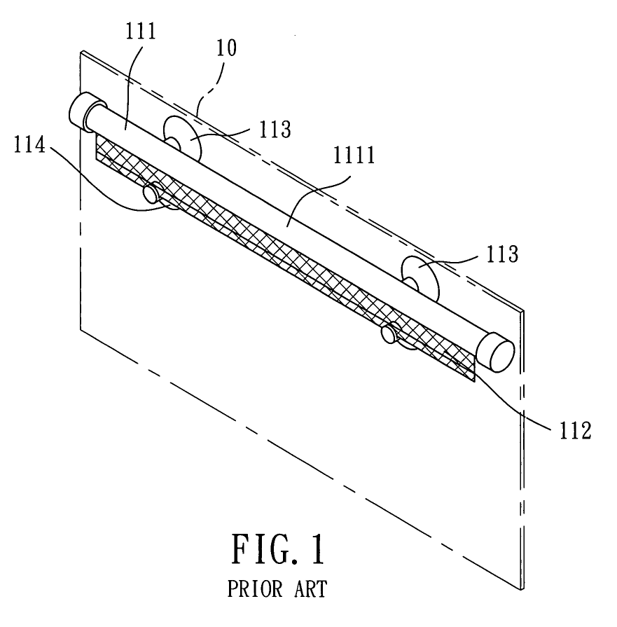

FIG. 2 is perspective view to illustrate a state where the conventional sunshade assembly is operated to cover a windowpane;

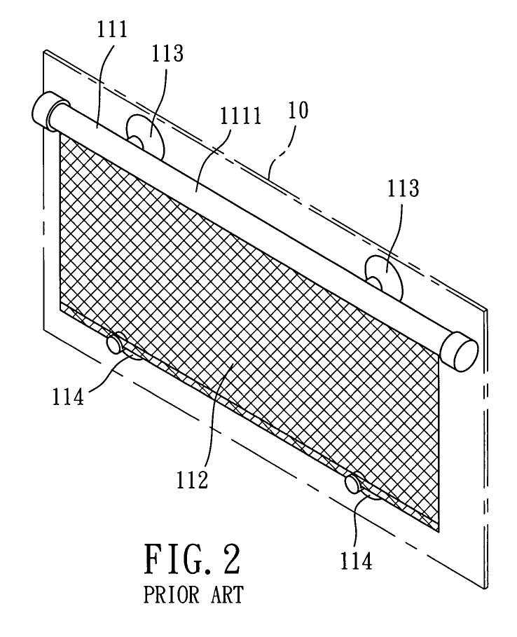

FIG. 3 is a perspective view of the preferred embodiment of a sunshade assembly according to the present invention;

FIG. 4 is a fragmentary sectional view of the preferred embodiment to illustrate a self-coiling spring strip secured to a flexible screen body;

FIG. 5 is a fragmentary perspective partly cutaway view of the preferred embodiment to illustrate a cross-section of the self-coiling spring strip when straightened;

FIG. 6 is a fragmentary perspective partly cutaway view of the preferred embodiment to illustrate a cross-section of the self-coiling spring strip when coiled; and

FIG. 7 is a perspective view to illustrate a state where the preferred embodiment is operated to uncover a windowpane.

### DETAILED DESCRIPTION OF THE PREFERRED EMBODIMENT

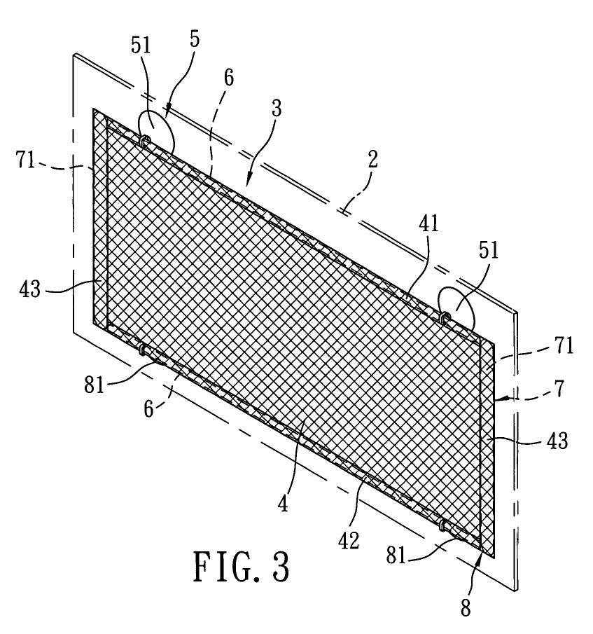

Referring to FIG. 3, the preferred embodiment of a sunshade assembly 3 according to this invention is shown to include a flexible screen body 4 and a self-coiling spring strip unit 7.

The sunshade assembly 3 of this embodiment is operable so as to cover and uncover a windowpane 2, in a manner that will be described hereinafter.

The flexible screen body 4 is generally rectangular in shape, and has opposite secured and free ends 41, 42, and opposite lateral ends 43.

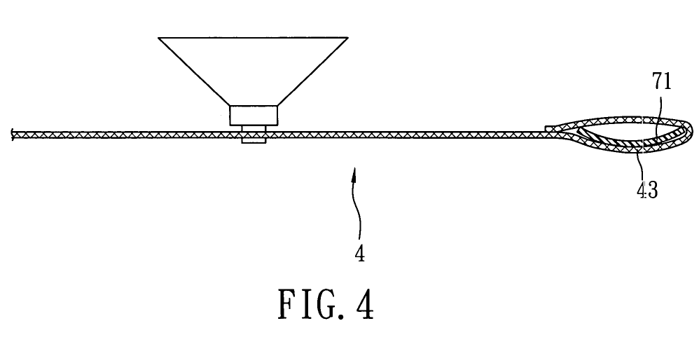

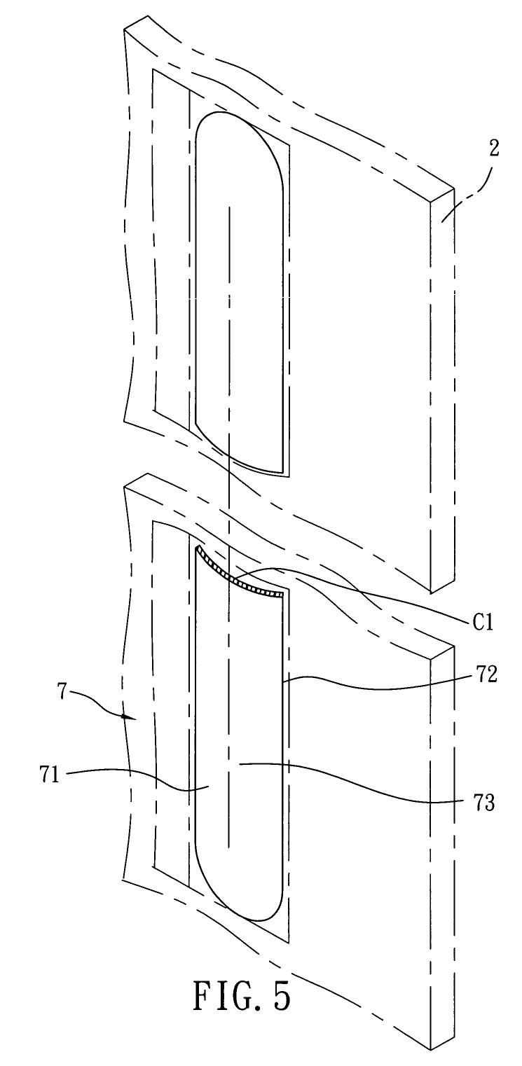

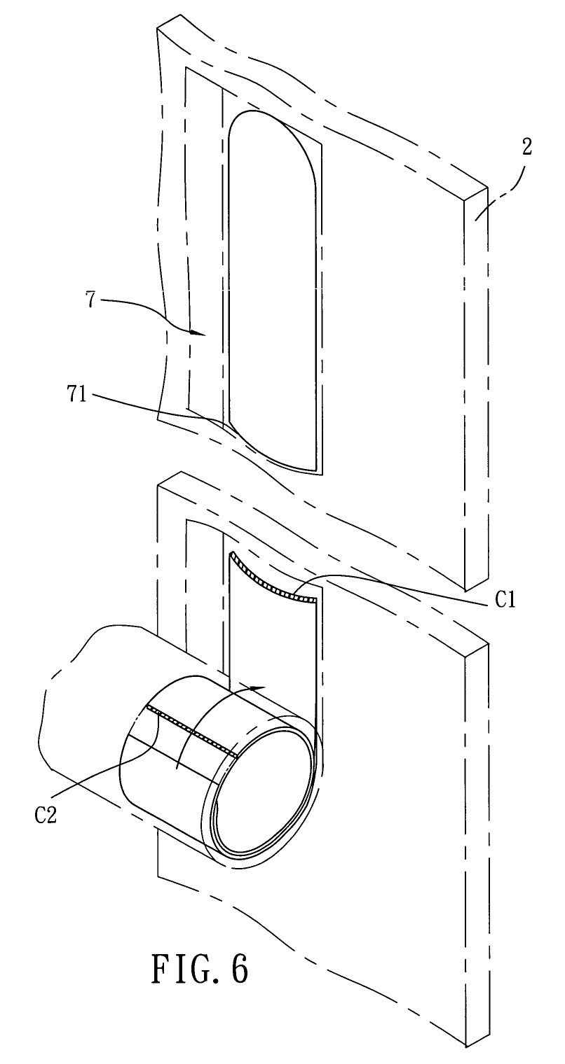

The self-coiling spring strip unit 7 includes a pair of self-coiling spring strips 71, each of which extends along the length of and is secured to a respective one of the lateral ends 43 of the flexible screen body 4. In particular, as best shown in FIG. 4, each of the lateral ends 43 of the flexible screen body 4 is folded to form a sleeve into which the respective one of the self-coiling spring strips 71 is inserted. In this embodiment, as best shown in FIGS. 5 and 6, each of the self-coiling spring strips 71 is deformable between a first state, where a cross-section (C1) of each of the self-coiling spring strips 71 (only one of the self-coiling spring strips 71 is shown in FIG. 5) is concave, and a second state, where the cross-section (C2) of each of the self-coiling spring strips 71 (only one of the self-coiling spring strips 71 is shown in FIG. 6) is flat.

The sunshade assembly 3 further includes a securing unit 5 that is provided on the secured end 41 of the flexible screen body 4 and that is attached removably on the windowpane 2. As such, the flexible screen body 4 is ensured to roll-up from the free end 42 thereof, rather from the secured end 41 thereof. In this embodiment, the securing unit 5 includes a pair of suction cups 51.

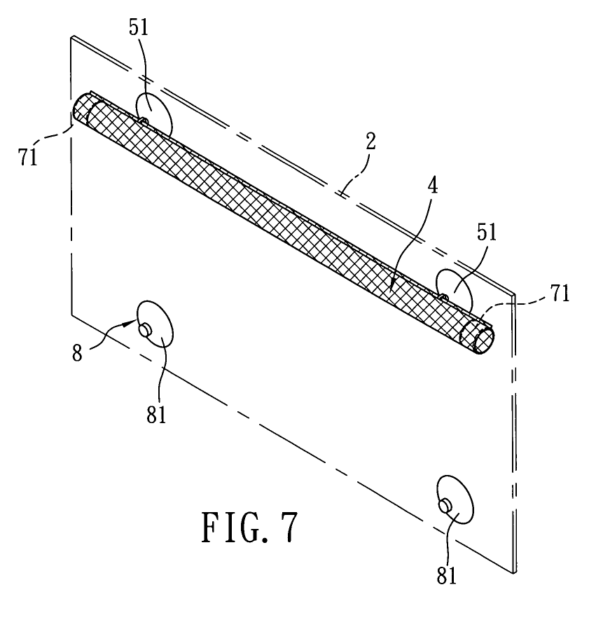

In operation, when it is desired to cover the windowpane 2, as best shown in FIG. 3, each of the self-coiling spring strips 71 is first straightened against a coiling force thereof. This in turn causes the flexible screen body 4 to unroll. It is noted that each of the self-coiling spring strips 71 deforms in the first state, when straightened, and is therefore held to remain substantially straight. At this state, a concave side 72 of each of the self-coiling spring strips 71 faces toward the windowpane 2. Thereafter, when it is desired to uncover the windowpane 2, as best shown in FIG. 7, each of the self-coiling spring strips 71 is bent, such as by pressing a convex side 73 thereof, which causes each of the self-coiling spring strips 71 to self-coil. This in turn causes the flexible screen body 4 to roll-up. It is noted that each of the self-coiling spring strips 71, when coiled, deforms in the second state.

The sunshade assembly 3 further includes a retaining unit 8 that is provided on the free end 42 of the flexible screen body 4, and that is attached removably to the windowpane 2 when the sunshade assembly 3 of this invention is operated to cover the windowpane 2. The construction as such prevents operation of the sunshade assembly 3 of this invention to uncover the windowpane 2 when the self-coiling spring strips 71 are accidentally bent. In this embodiment, the retaining unit 8 includes a pair of suction cups 81.

It is noted that each of the suction cups 81 of the retaining unit 8 may be either detached from the free end 42 of the flexible screen body 4 or the windowpane 2 to permit operation of the sunshade assembly 3 of this invention to uncover the windowpane 2. When each of the suction cups 81 of the retaining unit 8 is detached from the windowpane 2, and when the sunshade assembly 3 is operated to uncover the windowpane 2, each of the suction cups 81 of the retaining unit 8 is rolled-up with the flexible screen body 4. The suction cups 81 of the retaining unit 8 are pliable enough so as not to affect rolling-up of the flexible screen body 4.

The sunshade assembly 3 further includes first and second reinforcing strips 6, each of which extends across the length of and is secured to a respective one of the secured and free ends 41, 42 of the flexible screen body 4. In particular, each of the secured and free ends 41, 42 of the flexible screen body 4 is folded to form a sleeve into which the respective one of the first and second reinforcing strips 6 is inserted. The construction as such retains crosswise expansion of the flexible screen body 4. In this embodiment, each of the first and second reinforcing strips 6 is made from a deformable metal to thereby permit crosswise folding of the sunshade assembly 3.

It has thus been shown that the sunshade assembly 3 of this invention includes a flexible screen body 4, and a pair of self-coiling spring strips 71, each of which is secured to the flexible screen body 4 and provides a coiling force for biasing the flexible screen body 4 to self-roll. This results in a relatively simple structure for the sunshade assembly 3.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A sunshade assembly, comprising:
a flexible screen body having opposite lateral ends; and
a self-coiling spring strip unit including a pair of self-coiling spring strips, each of which is secured to and extends along the length of a respective one of said lateral ends of said flexible screen body.

2. (canceled)

3. The sunshade assembly as claimed in claim 1, wherein said flexible screen body having a secured end that extends transversely relative to the length of said flexible screen body, said sunshade assembly further comprising a securing unit provided on said secured end of said flexible screen body and adapted to be attached removably on a windowpane.

4. The sunshade assembly as claimed in claim 3, wherein said securing unit includes a suction cup.

5. The sunshade assembly as claimed in claim 3, wherein said flexible screen body further has a free end that is opposite to said secured end thereof, said sunshade assembly further comprising a retaining unit provided on said free end of said flexible screen body and adapted to be attached removably to the windowpane.

6. The sunshade assembly as claimed in claim 5, wherein said retaining unit includes a suction cup.

7. (canceled)

8. The sunshade assembly as claimed in claim 1, wherein each of said self-coiling spring strips is deformable between a first state, where a cross-section of each of said self-coiling spring strips is concave, and a second state, where the cross-section of each of said self-coiling spring strips is flat.

9. The sunshade assembly as claimed in claim 1, wherein each of said lateral ends of said flexible screen body is folded to form a sleeve into which the respective one of said self-coiling spring strips is inserted, thereby securing each of said self-coiling spring strips to the respective one of said lateral ends of said flexible screen body.

10. The sunshade assembly as claimed in claim 1, wherein said flexible screen body further has a secured end that extends transversely relative to the length of said flexible screen body, said sunshade assembly further comprising a first reinforcing strip that extends along the length of and that is secured to said secured end of said flexible screen body.

11. The sunshade assembly as claimed in claim 10, wherein said first reinforcing strip is made from a deformable metal.

12. The sunshade assembly as claimed in claim 10, wherein said flexible screen body further has a free end that extends across the length thereof and that is opposite to said secured end thereof, said sunshade assembly further comprising a second reinforcing strip that extends along the length of and that is secured to said free end of said flexible screen body.

13. The sunshade assembly as claimed in claim 12, wherein said second reinforcing strip is made from a deformable metal.
